(19) United States
(12) Patent Application Publication
(10) Pub. No.: US 2008/0203034 A1
(43) Pub. Date: Aug. 28, 2008

(54) Method of Inhibiting the Growth of Microorganisms

(75) Inventors: Petri Lindqvist, Kouvola (FI); Pertti Mattila, Porvoo (FI); Pekka Kultalahti, Kuukanniemi (FI)

Correspondence Address: OLIFF & BERRIDGE, PLC, P.O. BOX 320850, ALEXANDRIA, VA, 22320-4850, US

(73) Assignee: BIM KEMI AB, STENKULLEN (SE)

(21) Appl. No.: 11/883,947

(22) PCT Filed: Mar. 15, 2006
(86) PCT No.: PCT/FI06/50100

§ 371 Date: Aug. 8, 2007

(30) Foreign Application Priority Data
Mar. 16, 2005 (FI) 20055120

(51) Int. Cl. C02F 1/76

(52) U.S. Cl. 210/755

(57) ABSTRACT

The invention relates to a method of inhibiting the growth of microorganisms in fresh or circulating water by adding to the water, separately and essentially continuously, (1) an oxidant and (2) a bromine source.

### FIELD OF THE INVENTION

The present invention relates to a method of inhibiting the growth of microorganisms in fresh and circulating water in paper making and cardboard making processes.

### BACKGROUND OF THE INVENTION

Traditionally, in paper mills, the fresh water used in paper and board production is disinfected using sodium hypochlorite (NaOCl). In the 1990'ies NaOCl has been replaced in some countries partly by bromochlorodimethylhydantoin (BCDMH) for said purpose. BCDMH has been tested for inhibition of microorganism growth in paper making process and water circuits, too, but there has been no real general success/breakthrough in comparison to conventional biocides used in this process. Environment and conditions are quite different in a papermachine system in comparison to fresh water conditions. In paper mill water circuits, the presence of organic material determined e.g. as COD (COD=chemical oxygen demand) is typically high. Upon reaction with these organic components, NaOCl may produce adsorbable organic halogen (AOX) by-products, which are environmentally undesirable. In addition, the bactericidal efficiency of NaOCl is substantially reduced in high COD systems because of its rapid reaction with organic materials. In recirculating waters with high COD values, such as in paper and cardboard processing applications, these effects are well-known.

The European patent EP 785 909 teaches the combined use of dimethylhydantoin (DMH) and sodium hypochlorite (NaOCl) in order to reduce adsorbable organic halogen (AOX) by-product formation. The description of document EP 785 909 is a somewhat inconsistent and contradictory, but it is quite clear, e.g. from the examples, that said document does not teach the combined use of bromochlorodimethylhydantoin (BCDMH) and sodium hypochlorite. The document describes combined use of dimethylhydantoin (DMH) and sodium hypochlorite, only. These are chemically different materials. BCDMH is a known biocide, while DMH is not known to have any biocidal properties. The document teaches that BCDMH is an alternative to sodium hypochlorite, on the contrary to DMH. Thus, EP 785 909 is silent regarding any requirement of a bromine source for an effective program.

U.S. Pat. No. 5,976,386 teaches a method and apparatus for in situ production of an active biocidal ingredient. Here the publication teaches sodium hypochlorite and ammonium bromide for the production of this active biocidal ingredient. Ammonium bromide is defined as an amine source for an in situ production of an active biocidal ingredient. Nothing of the role of bromine is mentioned.

U.S. Pat. No. 5,641,520 describes a method for providing a disinfecting (cleaning) solution of Hbr, NaOCl and a dialkylhydantoin. According to the description (column 5, lines 4-5), the dialkylhydantoin may be added in the form of e.g. bromochlorodimethylhydantoin (BCDMH). The premixed solution obtained by the method may be used for the treatment of e.g. pulp and paper white water and process waters (column 9, lines 36-37). Said U.S. Pat. No. does not disclose, nor suggest, a method where the oxidant and the bromine source are added separately and continuously to the waters to be treated, but merely an intermittent addition of a premixed composition.

U.S. Pat. No. 4,119,535 discloses a supplemental treatment for swimming pool water and the like by treating the water with a material comprising a mixture of 1,3-dibromo-5,5-dimethylhydantoin (BBDMH) and either an inorganic alkaline or acidic reactive compound (NaCO₃ or NaHSO₄). Also according to this patent, a premixed composition is added discontinuously to the swimming pool water, the amount of the added composition being determined relative to the pH of the water prior to the addition. The patent in question does not disclose, nor suggest, essentially continuous, separate addition of an oxidant and a bromine source to process waters, such as those used in the paper making and the cardboard making processes.

Now, it has surprisingly been found that by adding separately and essentially continuously a bromine source, such as bromochlorodimethylhydantoin (BCDMH), and an oxidant, such as NaOCl, to fresh and/or circulating water in paper and cardboard making processes, excellent results are achieved in the inhibition of the growth of microorganisms in water, e.g. water in acidic, neutral and alkaline paper making processes.

The continuous and separate addition of the oxidant and the bromine source makes it possible to maintain an even distribution and concentration, without any peaks, of the growth inhibiting chemicals in the process waters. Thus, an improved inhibiting effect and a more economic performance are achieved.

### SUMMARY OF THE INVENTION

The present invention relates to a method of inhibiting growth of microorganisms in fresh or circulating water in a paper making or cardboard making process comprising adding to the water separately and essentially continuously

(1) an oxidant, and

(2) a bromine source.

### DETAILED DESCRIPTION OF THE INVENTION

The oxidant to be used in the method of the invention is suitably selected from the group consisting of sodium hypochlorite, lithium hypochlorite, potassium hypochlorite, calcium hypochlorite, magnesium hypochlorite, chlorine gas and chlorine dissolved in water. The oxidant is preferably sodium hypochlorite.

The bromine source is suitably selected from the group consisting of brominated hydantoins, combinations of a bromide salt with non-brominated hydantoins or cyanuric acid or chlorinated cyanurate, and combinations of bromine with non-brominated hydantoins. Examples of typical bromides to be used are lithium bromide, potassium bromide, calcium bromide, magnesium bromide and ammonium bromide. The hydantoins may have the methyl groups, one or both, replaced by other alkyl groups having up to 9 carbon atoms (e.g. ethyl, propyl, butyl, etc.). The bromine source is preferably bromochlorodimethylhydantoin (BCDMH) or dibromodimethylhydantoin (BBDMH), especially BCDMH.

Efficient inhibition of the growth of microorganisms is achieved

a) by dosing the components in fresh water intake before fresh water feeding to the paper making process.

b) by dosing one component in fresh water and other component(s) to the paper making process. If the component dosed to fresh water is the oxidant (NaOCl) or a halogenated hydantoin, it is preferred that there is a minimum of 2 ppm residual chlorine in the fresh water in the place where fresh water meets the process circuit, treated with the other components.

c) by dosing component(s) in fresh water and one component to the paper making process. If one or two of components dosed to fresh water is the oxidant (NaOCl) and/or a halogenated hydantoin, it is preferred that there is a minimum of 2 ppm residual chlorine in the fresh water in the place where fresh water meets the process circuit.

d) by direct dosing of the components to the paper making process.

If there is a natural or installed side stream from the process, where component(s) is/are dosed, the side stream is considered a part of the paper making process.

The other component(s) has/have to be dosed before or shortly after the dosing of the oxidant (NaOCl). If the dosing of other component(s) is/are after the dosing of the oxidant (NaOCl) and/or a halogenated hydantoin, it is preferred that there is locally an amount of 2 ppm or more free chlorine residuals at the dosing point(s).

As mentioned above, sodium hypochlorite (NaOCl) alternatively BCDMH has previously been used for disinfection of fresh water. When a chlorine-containing chemical is used for this purpose, the free chlorine amount remains below 2 ppm at the feeding point of fresh water to the paper manufacturing process circuit.

According to the invention, the optimum amounts of the bromine source, such as BCDMH (calculated as halogen) and oxidant, such as sodium hypochlorite (calculated as chlorine) corresponds to the molar ratio of about 1:1. However, because of the fact that process designs, process dynamicity, process running strategy and pH range of the process use to differ from each others, the optimal molar ratio may vary much. Typically the molar ration is between 1:15 and 15:1. When non-brominated hydantoin is used as a third component, typical molar ratios are 1:15:15 and 1:1:15 to 15:1:1 and 15:15:1 for non-brominated hydantoin (calculated as DMH), and bromine source (calculated as bromine or as halogen, if the source is BCDMH) and oxidant, such as sodium hypochlorite (calculated as chlorine). Thus the relative minimum amount of a component is 1 in relation to 15 for other component(s) and the maximum amount of a component is 15 times in relation to 1 to other component(s).

Typically active chlorine concentrations of min 0.1 to max 15 ppm are added and maintained in the process waters. The addition of other components are proportioned in amounts as described above. Typically the required addition rate as halogen is min. 3 g and max. 1500 g per produced ton of paper. Advantageously the amounts are between 10 g and 500 g per produced paper ton. The amounts required depend on the water volume of the process, process design, process dynamicity, COD concentration of the process waters and the pH range of the process. The temperature of the process has an influence as well. A process temperature at above 60° C. begins to reduce the efficiency because of too vigorous reactivity with organic impurities (COD). The present method of inhibiting the growth of microorganisms in a paper making process works optimally within the pH range of 7 to 9. However, the invention can be applied advantageously across the whole paper making pH range, which is from 4.0 to 10.5.

The components used in accordance with the present invention are in general compatible with other paper making additives. Thus, for instance, it is possible to use the invention together with conventional biocides, such as chlormethyl- and methylisothiazolones, glutardialdehyde, peracetic acid, dibromonitrilopropionamide, and bronopol e.g. for preservation.

The following examples illustrates the invention, but are not intended to limit it.

### EXAMPLE 1

The combined use of sodium hypochlorite (NaOCl) and bromochlorodimethylhydantoin (BCDMH) significantly increases the microbiological inhibiting efficiency compared to the situation where said components are used alone. The test media was a broke filtrate water from a paper making process. The pH of the filtrate water was 9, and the COD was 1800 mg/l. The filtrate water in the test vessel was under continuous stirring. The addition time of chemicals was 10 minutes to simulate process conditions. The amount of colony forming units (cfu) was determined by the plate count agar method (incubation time 48 h at 37° C.). The results are shown in Table 1.

TABLE 1

| | ppm | stirring time after dosing | | |
|---|---|---|---|---|
| | total | reference | 1 h | 3 h |
| Chemistry used | halogen | bacteria accountings cfu/ml process water | | |
| NaOCl | 6 | 6E8 | 7E5 | 3E6 |
| | 3 | 4E8 | 6E6 | 4E6 |
| | 1 | 5E8 | 7E7 | 1E8 |
| BCDMH | 6 | 2E8 | 2E7 | 5E5 |
| | 3 | 7E8 | 6E7 | 7E6 |
| | 1 | 5E8 | 8E7 | 8E7 |
| NaOCl + BCDMH | 6 | 7E8 | 2E6 | <E3 |
| (Cl₂) + BrCl) = 1:1 | 3 | 5E8 | 5E6 | <E3 |
| separate dosing | 1 | 4E8 | 2E7 | 3E3 |
| NaOCl + DMH + | 6 | 3E8 | 2E6 | <E3 |
| NH₄Br | | | | |
| (Cl₂ + DMH + | 3 | 7E8 | 2E6 | <E3 |
| Br) = 1:1:1 | | | | |
| separate dosing | 1 | 5E8 | 9E6 | <E3 |

The combined use of NaOCl and BCDMH significantly increased the microbial inhibition efficiency under the described conditions compared to the use of either component alone. The results also show improved efficiency compared to the use of NaOCl and DMH together. The use of a separate bromine source, like ammonium bromide, with NaOCl and non-brominated hydantoin, gives excellent results, comparable to those of the combined use of NaOCl and BCDMH.

### EXAMPLE 2

The test was carried out as in example 1, but the process water was from another paper machine process where the pH value was 7 and COD 2200 mg/l. The results are shown in Table 2.

TABLE 2

| | ppm | stirring time after dosing | | |
|---|---|---|---|---|
| | total | reference | 1 h | 3 h |
| Chemistry used | halogen | bacteria accountings cfu/ml process water | | |
| NaOCl | 6 | 3E9 | 2E5 | 2E6 |
| | 3 | 1E9 | 7E5 | 3E6 |
| | 1 | 4E9 | 6E7 | 2E7 |
| BCDMH | 6 | 7E8 | 3E6 | 7E5 |
| | 3 | 4E9 | 6E6 | 9E5 |
| | 1 | 3E9 | 2E7 | 4E6 |
| NaOCl + BCDMH | 6 | 2E9 | 2E5 | <E3 |
| (Cl₂) + BrCl) = 1:1 | 3 | 9E8 | 8E5 | <E3 |
| separate dosing | 1 | 4E9 | 2E6 | 3E3 |

The combined use of NaOCl and BCDMH shows a clear efficiency improvement compared to the use of either of the components in isolation also in process waters at pH 7.

### EXAMPLE 3

The effect of different molar ratio between the components was tested by using the same process water and in same way as in example 1.

TABLE 3

| | | | stirring time after dosing | | |
|---|---|---|---|---|---|
| | | | reference | 1 h | 3 h |
| | | ppm total | bacteria accountings | | |
| Chemistry used | | halogen | cfu/ml process water | | |
| NaOCl + BCDMH | 1:1 | 3 | 7E8 | 3E6 | <E3 |
| as mole ratio of | 1:4 | 3 | 9E8 | 8E6 | 2E4 |
| Cl₂:BrCl | 1:0.3 | 3 | 7E8 | 7E5 | <E3 |
| NaOCl + DMH + NH₄Br | 1:3:5 | 3 | 8E8 | 1E7 | 5E5 |
| as mole ratio | 2:1:0.3 | 3 | 4E8 | 9E5 | <E3 |
| Cl₂:DMH:Br | | | | | |
| BCDMH | | 3 | 5E8 | 2E7 | 7E6 |

The test shows that the desired effect is achieved within a wide molar ratio of the components. However, the test shows that, under the test conditions, the combination is effective, if the amount of the oxidant (NaOCl) is dominative.

### EXAMPLE 4

In this example, the tests were carried out during a process trial in a paper making process. The paper mill produces about 600 ton paper per day. The water volume of the process is about 5000 m³. The volume circulates in the process about 2 times per day. Thus, the daily treatment volume is about 10000 m³. Because of the process design the main stream circulates a bit quicker than twice a day, but there are in the process side streams, which participate in the circulation much more slowly. Thus, there are places in the process circuit, where the entire water change may last several days. During the last two years the microbiological growth control of the process was effected using conventional competitive biocides such as per acetic acid and glutardialdehyde. The costs of this treatment were 0.85 [symbol] /produced paper ton and 500 [symbol] /day.

This earlier treatment resulted in bacteria amounts in the process that have been regularly between 1E7 and 1E10 cfu/ml throughout the process.

In a process trial with a system according to the invention the dosing amounts were chosen so that they are comparable with treatment costs of the earlier ones. In the trial run the dosing amounts were the following: BCDMH 30 kg/day and NaOCl 300 kg/day. The NaOCl had a chlorine content of 10%. Thus, the active chlorine addition is 30 kg/day. The dosing was arranged separately to a broke filtrate vessel of 20 m³. In this process the pH varies from 7.9 to 9.2 and the temperature between 38 and 47° C.

The results are shown in Table 4, where samples for bacteria plate counts were taken from several representative places of the process water circuit. These sampling places were broke filtrate, white water tank, soft wood pulp (diluted with process water), hard wood pulp (diluted with process water), broke pulp (pulped with process water) and head box pulp. Reference samples were taken just before start up of continuous additions at 07.02.2005 at 10.45 am, and then samples were taken several times during 8 trial run days as shown in Table 4.

TABLE 4
Bacteria amounts in the process, cfu/ml

| | | Broke fil- | White wa- | Softwood | Hardwood | Broke | Head box |
|---|---|---|---|---|---|---|---|
| Day | Time | trate | ter tank | pulp | pulp | pulp | pulp |
| 07 Feb. 2005 | 10.45 | 2E8 | 4E7 | 2E7 | 1E7 | 6E7 | 3E7 |
| 07 Feb. 2005 | 13.45 | <E3 | 3E6 | 2E7 | 9E6 | 1E7 | 3E7 |
| 08 Feb. 2005 | 09.30 | <E3 | 4E4 | 8E5 | 1E5 | 2E5 | 4E6 |
| 08 Feb. 2005 | 13.45 | <E3 | <E3 | 3E5 | 5E4 | 2E4 | 3E6 |
| 09 Feb. 2005 | 09.45 | 2E3 | 1E3 | 1E5 | 2E4 | 2E4 | 2E6 |
| 10 Feb. 2005 | 08.15 | <E3 | 1E3 | 2E5 | 1E5 | 9E4 | 5E6 |
| 14 Feb. 2005 | 09.15 | <E3 | <E3 | 1E3 | 2E3 | 3E4 | 3E5 |
| 15 Feb. 2005 | 08.30 | <E3 | <E3 | <E3 | 1E3 | 2E4 | 4E4 |

The results show that the combined use of NaOCl and BCDMH has excellent efficiency in real process use.

1. A method of inhibiting the growth of microorganisms in fresh or circulating water in a paper making or cardboard making process, comprising adding to the water separately and essentially continuously
(1) an oxidant selected from a group consisting of sodium hypochlorite, lithium hypochlorite, potassium hypochlorite, calcium hypochlorite and magnesium hypochlorite, and
(2) a bromine source selected from bromochlorodimethylhydantoin (BCDMH) and dibromodimethylhydantoin (BBDMH).

2. The method according to claim 1, wherein the oxidant (1) is sodium hypochlorite.

3. The method according to claim l, wherein the bromine source (2) is BCDMH.

4. The method according to claim l, wherein the bromine source (2) is BBDMH.

5. The method according to claim 2, wherein the bromine source (2) is BCDMH.

6. The method according to claim 2, wherein the bromine source (2) is BBDMH.
